(19) United States
(12) Patent Application Publication
(10) Pub. No.: US 2003/0154473 A1
(43) Pub. Date: Aug. 14, 2003

(54) Apparatus and method for controlling electronic program guide (EPG)

(76) Inventor: Su Hyun Shin, Taegu (KR)

Correspondence Address: BIRCH STEWART KOLASCH & BIRCH, PO BOX 747, FALLS CHURCH, VA, 22040-0747, US

(21) Appl. No.: 10/329,681

(22) Filed: Dec. 27, 2002

(30) Foreign Application Priority Data
Feb. 8, 2002 (KR) 2002-7448

(51) Int. Cl. H04N 7/16; G06F 3/00; H04N 5/445; G06F 13/00

(52) U.S. Cl. 725/28; 725/45; 725/47

(57) ABSTRACT

An apparatus and method for controlling an electronic program guide (EPG) display are provided. The method includes displaying an EPG on a display device, receiving a selection of a particular channel from the displayed EPG, comparing parental rating information of the selected channel with prestored parental rating information, and selectively displaying, in the EPG, program information of the selected channel based on the comparison results The apparatus and method prevent display of any inappropriate channel/program information in the EPG according to a user's set parental rating information.

This application claims the priority benefit of the Korean Patent Application No. P2002-7448 filed on Feb. 8, 2002, the entire contents of which are herein fully incorporated by reference.

### BACKGROUND OF THE INVENTION

1. Field of the Invention

The present invention relates to a display device, and more particularly, to a display device such as a TV and a method for displaying an electronic program guide (EPG) on the display device.

2. Discussion of the Background Art

A related art TV and a method for controlling the same will be explained with reference to the attached drawings.

Generally, a TV set includes a user input device such as a remote control, an audio/video (A/V) processing unit for processing video/audio information, a data parsing unit for separating various channel information from the obtained video information, a database for storing the separated channel information, and a controller for controlling the operation of the TV and the display of the EPG

When a broadcast signal is received by the TV, a demultiplexer separates audio/video information and channel service information from the broadcast signal. The separated audio/video information is applied to the A/V processing unit, whereas the separated channel service information is applied to the data parsing unit.

The channel service information generally includes PAT (Program Association Table), TDT (Time Date Table)/TOT (Time Offset Table), EIT (Event Information Table), and the like. The PAT contains information on a plurality of programs, the TDT/TOT contains information on the preset time of the programs, and the EIT contains information on program titles, program outlines, broadcasting parental ratings, start/end times, periods of displays, etc. The data parsing unit separates the EIT information from the channel service information, and stores it in the database in a predetermined format.

FIG. 1 shows an example of an EPG displayed on a general TV screen. As shown in FIG. 1, the EPG displays a list of channels or stations and their corresponding programs assigned to different time slots.

FIG. 2 shows an example of an EPG of the TV when a viewer selects a particular channel from the EPG of FIG. 1. In this example, the viewer has selected the channel/service “MBC TV” from the EPG and thus, the EPG displays the detail information of the current program and the next program scheduled for that channel according to the present time.

As shown in FIGS. 1 and 2, the stored channel service information is presented in an EPG menu screen according to the user's order, inclusive of the current and next program information of each channel. The EPG displays a list of a plurality of channels, the present time information, program titles (A), broadcasting time periods (B), and program outlines (C).

When a parental rating is set by a user (e.g., a parent), the controller reads the EIT information of each channel from the database, and extracts the parental rating information from the EIT information. Then, the controller compares the extracted parental rating to the user's set parental rating, and controls the audio and video processing to block a display of any program with a parental rating higher than the user's set parental rating.

Referring to Table 1 below, each program on the plurality of channels is given a relevant parental rating according to the degree of lasciviousness and violence in the program. Information on a parental guide code of the program (for example, a data code of hexadecimal digits) is received as part of the channel service information together with the audio and video broadcast signals.

TABLE 1

| Rating Hex Code | Parental Guide Code |
|---|---|
| 0*00 | Not Classified |
| 0*01 | |
| 0*02 | P (Pre School) |
| 0*03 | |
| 0*04 | C (Children) |
| 0*05 | |
| 0*06 | G (General) |
| 0*07 | |
| 0*08 | PG (Parental Guidance Recommended) |
| 0*09 | |
| 0*0A | M (Mature Audience 15+) |
| 0*0B | |
| 0*0C | MA (Mature Adult Audience 15+) |
| 0*0D | |
| 0*0E | AV (Adult Audience, Strong Violence 15+) |
| 0*0F | R (Restricted 18+) |

A general method for controlling the display of programs on the forgoing TV set using a general parental control mechanism will now be explained referring to FIG. 3. FIG. 3 shows a flow chart illustrating a general method of controlling a TV.

Referring to FIG. 3, when a viewer (e.g., a child) selects a particular channel to view using a remote control (S10), a user's (e.g., a parent's) setting of a parental rating for this viewer is determined (S11). As a result of this determination (S11), if the parental rating for this viewer is not set by the user, then the selected channel is tuned (S12) to be displayed to the viewer. But, as a result of the determination (S11), if the parental rating for this viewer has been set by the user, the selected channel is tuned (S13), and then the information on the parental rating of the selected channel (program) is extracted from the channel service information associated with the selected channel (S14). If it is determined that the extracted parental rating of the selected channel is equal to or lower than the user's set parental rating for the viewer (S15), then the audio and video of the program on the tuned channel are played on the TV screen for the viewer's viewing (S16).

On other hand, if it is determined at step S15 that the extracted parental rating of the selected channel is higher than the user's set parental rating for this viewer, then the audio and video of the program on the selected tuned channel are blocked, and the selected channel (program) is not displayed at all to the viewer (S17).

FIG. 4 shows an example of an EPG screen for setting a parental rating. In detail, on the screen as shown in FIG. 4 which permits the user to set various environments of the TV set, the user can select a parental rating by selecting an appropriate rating from the list, to restrict the viewing of programs according to the parental rating. For example, if the user sets the parental rating to be ‘M’ (Mature Audience), in a case where the parental rating of a program of a channel that a viewer has selected to view is equal to or lower than ‘M’ (e.g., P, C, G, PG, or M), then the selected program is displayed to the viewer. But, in a case where the parental rating of the program of the channel that the viewer has selected is higher than ‘M’ (e.g., MA, AV, R), then the selected program is blocked and is not displayed to the viewer.

In one example, a single parental rating may be set for all viewers of a TV set. In another example, the user can set different parental ratings for different viewers (e.g., for different children) of the TV set by setting a particular parental rating in association with a user ID/password of a particular viewer.

As discussed above, the related art TV and method for displaying an EPG of the TV restrict displaying of certain programs to one or more viewers according to the user's set parental rating, so as to protect children and minors from inappropriate, and often lascivious and violent, adult programs. However, when the EPG menu providing program information on each channel is displayed, program titles and outlines of the adult programs are automatically and always displayed to all viewers. This tempts unauthorized viewers to view such programs, which in turn encourages these viewers to find unauthorized and inappropriate ways to obtain access to such programs. Furthermore, it exposes some degree of such adult programs to unauthorized viewers, thereby failing to fully protect children and minors from such programs.

### SUMMARY OF THE INVENTION

Accordingly, the present invention is directed to a TV and a method for displaying an electronic program guide (EPG) of a TV that substantially obviates one or more of the problems due to limitations and disadvantages of the related art.

An object of the present invention is to provide a TV and a method for displaying an EPG, which can block, not only the displaying of an inappropriate program itself on the TV, but can block the displaying of program information on the program in an EPG according to a user's set parental rating.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for controlling an electronic program guide (EPG) for a display device according to an embodiment of the present invention, includes displaying an EPG on the display device; receiving a selection of a particular channel from the displayed EPG; comparing parental rating information of the selected channel with prestored parental rating information; and selectively displaying, in the EPG, program information of the selected channel based on the comparison results.

A method for controlling an electronic program guide (EPG) for a display device according to another embodiment of the present invention, includes receiving an EPG display command; comparing parental rating information of a current program for each of channels with prestored parental rating information responsive to the EPG display command; and displaying the EPG, which selectively excludes a display of channel information on certain channels in the EPG, based on the comparison results.

A method for controlling an electronic program guide (EPG) for a display device according to another embodiment of the present invention, includes receiving an EPG display command; comparing, for each of channels, parental rating information of at least one program corresponding to an EPG displayable time duration, with prestored parental rating information responsive to the EPG display command; and displaying the EPG, which selectively excludes a display of at least a portion of program information of certain channels in the EPG, based on the comparison results.

An apparatus for controlling an electronic program guide (EPG) according to an embodiment of the present invention, includes a display device to display thereon an EPG; an input unit to receive a selection of a particular channel from the displayed EPG; and a controller to compare parental rating information of the selected channel with prestored parental rating information, and to selectively display, in the EPG, program information of the selected channel based on the comparison results.

An apparatus for controlling an electronic program guide (EPG) according to another embodiment of the present invention, includes an input unit to receive an EPG display command; a controller to compare parental rating information of a current program for each of channels with prestored parental rating information responsive to the EPG display command; and a display device to display the EPG, which selectively excludes a display of channel information of certain channels in the EPG, based on the comparison results.

An apparatus for controlling an electronic program guide (EPG) according to another embodiment of the present invention, includes an input unit to receive an EPG display command; a controller to compare, for each of channels, parental rating information of at least one program corresponding to an EPG displayable time duration, with prestored parental rating information responsive to the EPG display command; and a display device to display the EPG, which selectively excludes a display of at least a portion of program information of certain channels in the EPG, based on the comparison results.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows an example of an EPG screen on a general TV;

FIG. 2 is an example of an EPG screen when a particular channel has been selected from the EPG menu;

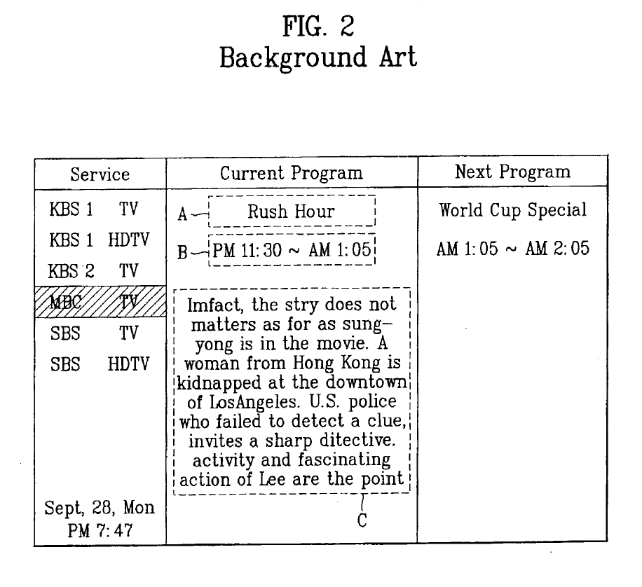

FIG. 3 is a flow chart illustrating a general method of selectively displaying programs to a viewer based on parental rating information;

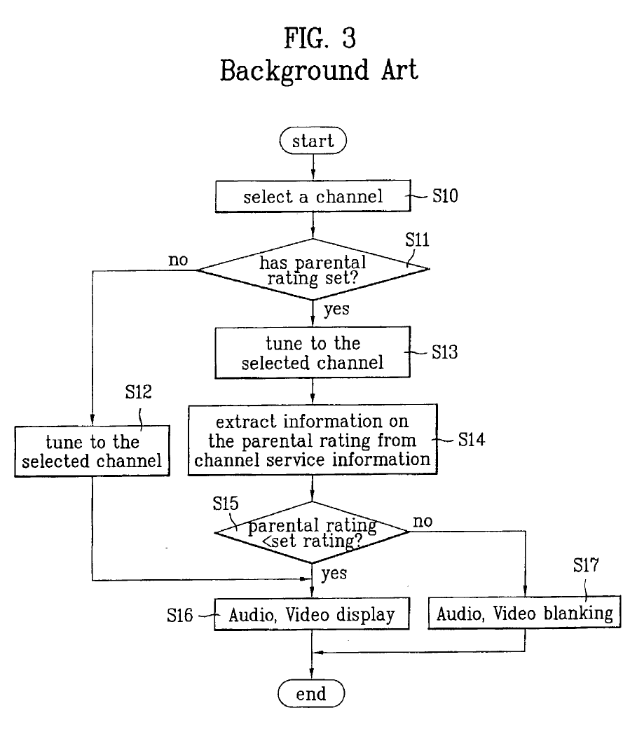

FIG. 4 is an example of an EPG screen for setting user parameters such as parental ratings;

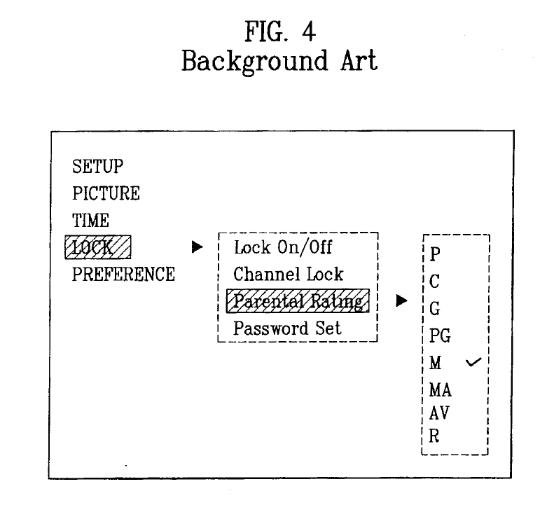

FIG. 5 is an example of a block diagram of a TV system according to an embodiment of the present invention;

FIG. 6 is a flow chart illustrating the steps of a method of displaying EPG information on a display device according to a first embodiment of the present invention;

FIG. 7 is an example of an EPG screen in which the method according to the first embodiment has been implemented;

FIG. 8 is a flow chart illustrating the steps of a method of displaying EPG information on a display device according to a second embodiment of the present invention;

FIG. 9 is an example of an EPG screen in which the method according to the second embodiment has been implemented;

FIG. 10 is a flow chart illustrating the steps of a method of displaying EPG information on a display device according to a third embodiment of the present invention; and

FIG. 11 is an example of an EPG screen in which the method according to the third embodiment has been implemented.

### DETAILED DESCRIPTION OF THE PREFERRED EMBODIMENTS

Reference will now be made in detail to the preferred embodiments of the present invention, examples of which are illustrated in the accompanying drawings.

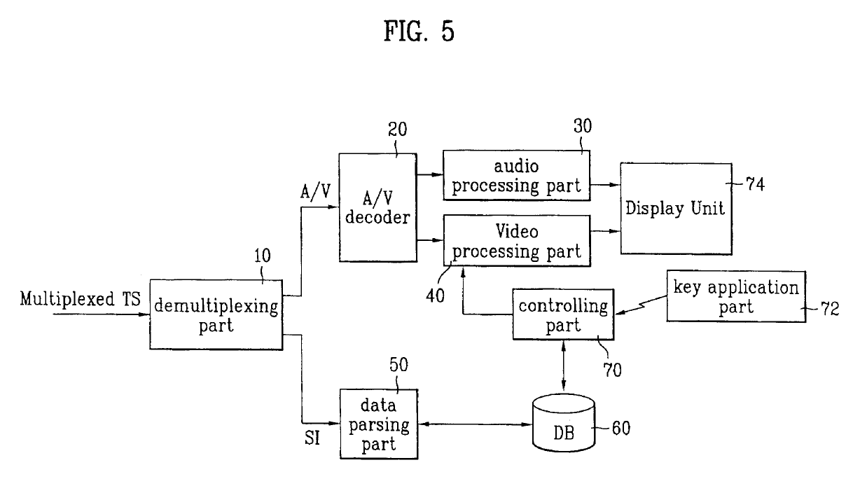

FIG. 5 is an example of a block diagram of a display system such as a TV system according to an embodiment of the present invention. Referring to FIG. 5, the display system is provided with: a user input unit or key application part 72 for a user to input an EPG display order and to set a parental rating; a demultiplexing part 10 for demultiplexing a broadcasting signal received by the display system, where the broadcast signal carrying multiplexed TS (Transport Stream) information is demultiplexed into audio, video, and service (channel service) information; an A/V decoder 20 for decoding the demultiplexed audio and video information into audio information and video information; an audio processing part 30 for processing the decoded audio information to produce audio parts of programs; a video processing part 40 for processing the decoded video information to produce video parts of the programs; a data parsing part 50 for parsing the separated service information to obtain various channel information; a database or other storage unit 60 for storing therein the obtained channel information; and a controlling part 70 for controlling the display system to selectively display on a display unit 74 certain stored channel information according to the EPG display order in an EPG, and selectively blocking displaying of certain programs on the display unit 74 according to the user's set parental rating.

The operation of the display system of FIG. 5 will be explained according to an embodiment of the present invention.

The demultiplexing part 10 receives and demultiplexes an input broadcasting signal composed of audio, video and service information, and provides the audio and video information to the A/V decoder 20 and the service information to the data parsing part 50.

The service information has PAT (Program Association Table), TDT (Time Date Table)/TOT (Time Offset Table), EIT (Event Information Table), etc. The PAT contains in formation on a plurality of programs, the TDP/TOT contains information on the preset time of the programs, and the EIT contains information on program titles, program descriptions/outlines, broadcasting parental ratings each pre-assigned to each of the programs to be broadcasted, program start/end times, and periods or durations of display, etc.

The A/V decoder 20 receives and decodes the audio and video information. The decoded audio information is realized as voice/sounds through the audio processing part 30 and the video information is realized as pictures/images through the video processing part 40.

The data parsing part 50 receives the service channel information, separates the EIT information from the service information, and stores the EIT information in the database 60 in a predetermined format for displaying program information in an EPG.

A method for displaying an EPG of a TV according to the embodiments of the present invention will now be explained below. It is assumed that a parental rating of a TV is preset by a user (e.g., a parent or guardian) for restricting viewing of certain portions of broadcasted programs and EPG for one or more viewers (e.g., children, minors, users, etc.). In one example, the user may set a single parental rating for all viewers of the TV. In another example, the user may set different parental ratings for different viewers (e.g., different children) of the TV. These parental rating settings can be accomplished using existing methods.

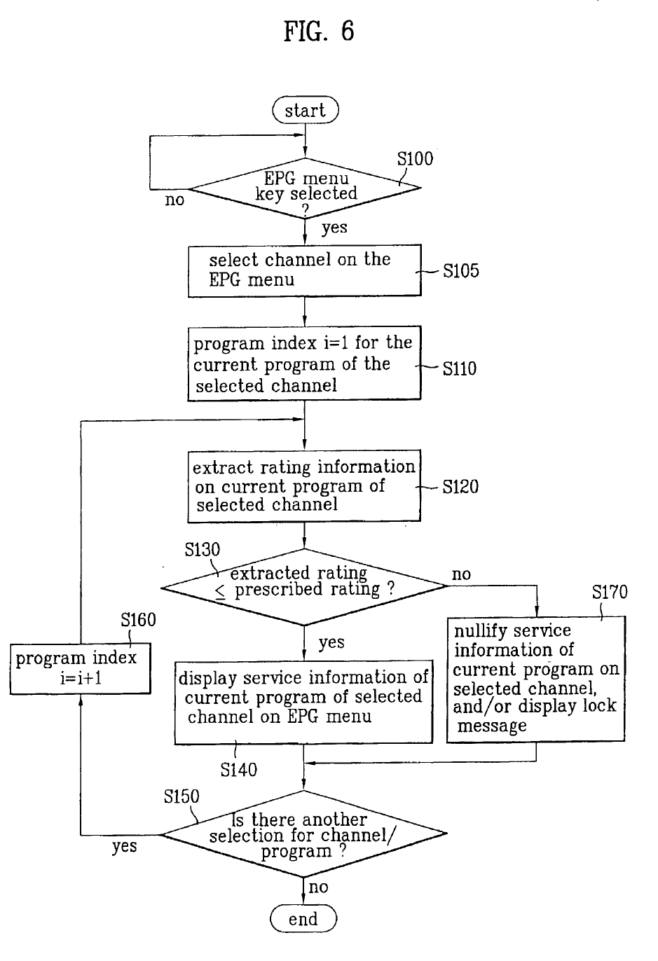

FIG. 6 is a flow chart illustrating the steps of a method of displaying EPG information on a display device according to a first embodiment of the present invention. This method is implementable by the display system shown in FIG. 5.

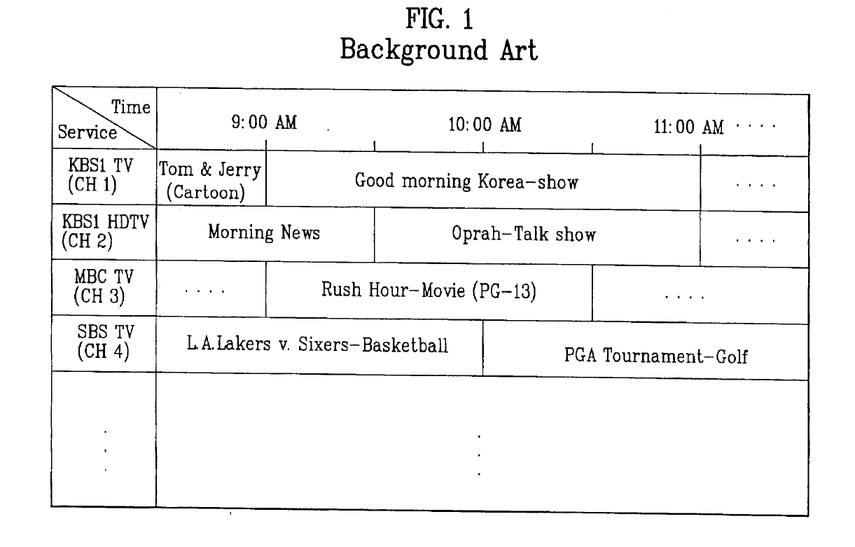

Referring to FIG. 6, it is determined whether or not a viewer has selected an ‘EPG display key’ to display an EPG menu on a display device screen (S100). If so, the EPG menu (e.g., the EPG screen shown in FIG. 1) is displayed on the display device screen (e.g., a TV screen or the display unit 74). The viewer selects a particular channel/station from the EPG menu, e.g., by using a remote controller or by voice activation (S105). Here, the selection of the channel implies the selection of a program. An integer ‘1’ is set for a program index (i) (S110). The program index (i) is used to indicate the number of programs that have been selected by the viewer. In other examples, any preset value may be set for the program index (i) at step S110.

Then, parental rating information of the current program of the selected channel is extracted (S120). This can be accomplished by examining the EIT information stored in the database 60 and extracting, e.g., the parental rating pre-assigned to the current program of the selected channel from the EIT information by the controlling part 70.

The extracted parental rating is then compared with the user's set parental rating (S130). Here and in other embodiments, as discussed before, the user's set parental rating may differ for different viewers who will be identifiable based on viewer ID/passcode information, or may be the same for all viewers of the display device.

If the extracted parental rating of the current program of the selected channel is equal to or lower than the user's set parental rating, then the service information of the current program of the selected channel is displayed in the EPG (S140). Thereafter, it is determined if there is another selection by the viewer for a different channel/program (S150). If there is another selection, then the program index is increased by one (S160) to monitor the number of selections made by the viewer, and the process returns to step S120.

On the other hand, if it is determined that the extracted parental rating of the current program is higher than the user's set parental rating (S130), then a channel list of the EPG is displayed as it is, but certain parts of the program information associated with the selected channel are left blank and/or messages such as “PROGRM LOCK” (S170) are displayed in the EPG. For example, the title and the outline of the current program of the selected channel on the EPG screen may be left blank. That is, at least parts of the program information pertaining to the selected channel are blocked and prevented from viewing if the current program of the selected channel has a parental rating which is inappropriate for the current viewer. Thereafter, the process returns to step S150.

It should be noted that steps S110 and S160 may be omitted from the method since they are provided if the user or other party desires to monitor the number of selections made by the viewer.

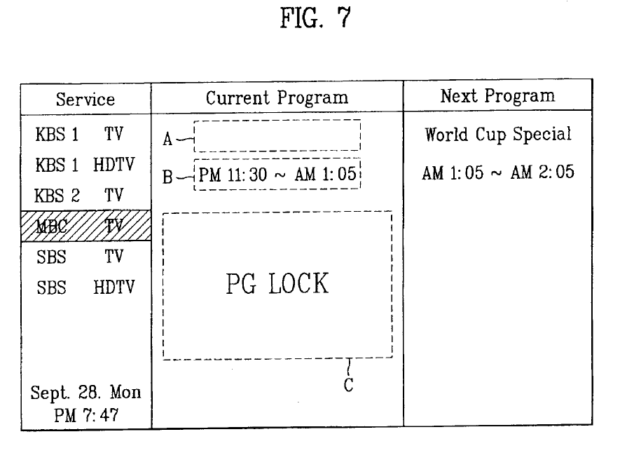

FIG. 7 is an example of an EPG screen displayable at step S170 of FIG. 6. As shown in FIG. 7, if a current program of the viewer selected channel ‘MBC TV’ of the EPG has a parental rating higher than the user's set parental rating for the viewer, then spaces for the title (A) and outline (C) of this program are left blank on the EPG, and/or a predetermined message (e.g., “PG LOCK”) is displayed on the EPG.

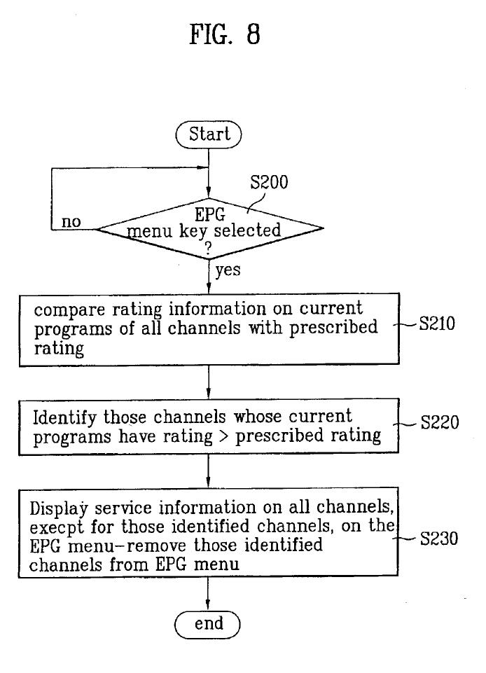

FIG. 8 is a flow chart illustrating the steps of a method for displaying EPG information a display device according to a second embodiment of the present invention. This method in implementable by the display system shown in FIG. 5.

Referring to FIG. 8, it is determined whether or not a viewer has selected an ‘EPG key’ or the like, for example, by using a remote control or by voice-activation, to display an EPG menu on a display device screen (S200). Step S200 is the same as step S100 of FIG. 6.

If the viewer has selected the ‘EPG display key’ or the like, the parental rating information on the current programs of all channels is extracted (e.g., from the EIT information stored in the database 60). Each parental rating assigned to the current program of each of the channels is then compared with the user's set parental rating (S210). Then, those channels whose current programs have a parental rating higher than the user's set parental rating are identified (S220). Here, one or more channels may be identified, or no channel may be identified.

Then the service/program information (e.g., titles, outlines, etc.) on all channels is displayed on the display device along with the list of channels, as part of the EPG menu, except for those identified channels and the service/program information of those identified channels (S230). That is, the channel listings and the program information of those channels whose current programs have a parental rating greater than the user's set parental rating, will be completely removed from the EPG menu, such that the service information pertaining to those channels and even the names of those channels are not displayed on the EPG menu screen.

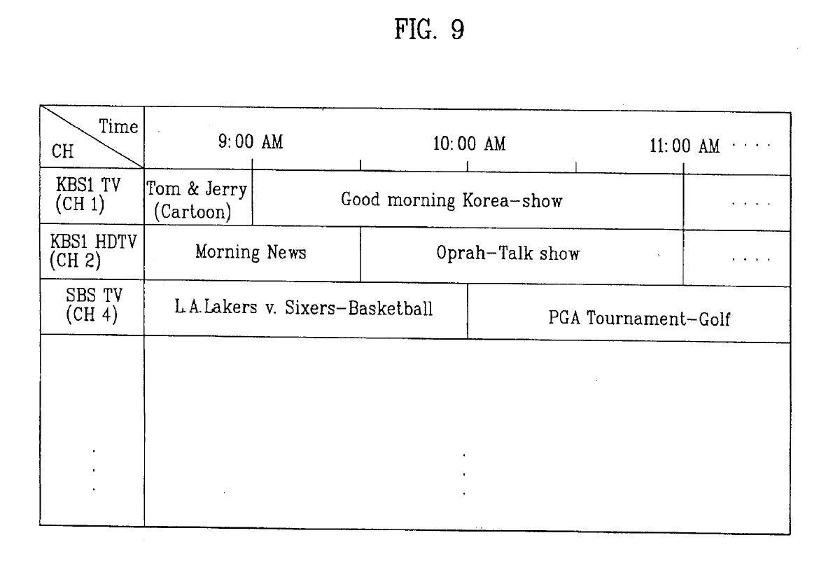

FIG. 9 is an example of an EPG screen in which the method of FIG. 8 has been implemented. Referring to FIG. 9, the channel listing (e.g., channel name) as well as the program information (e.g., title, outline, etc.) of any channel whose current program has a parental rating that is inappropriate for the current viewer (e.g., based on the parental rating comparison results) are omitted from the EPG screen. In this example, Channel 3 (“MBC TV”) and its program information are not shown in the EPG of FIG. 9 compared to the general EPG of FIG. 1 showing all channels. Thus, any temptation of the viewer to view inappropriate programs, arising from the viewing of the EPG, will be completely removed, and the viewer will not be exposed to any inappropriate information even from the EPG.

In FIG. 9, in a case where the next program of Channel 3 (MBC TV channel) has a parental rating equal to or lower than the user's set parental rating, then the name of Channel 3 and the next program information are displayed again as part of the EPG menu screen when the next program broadcasting time comes.

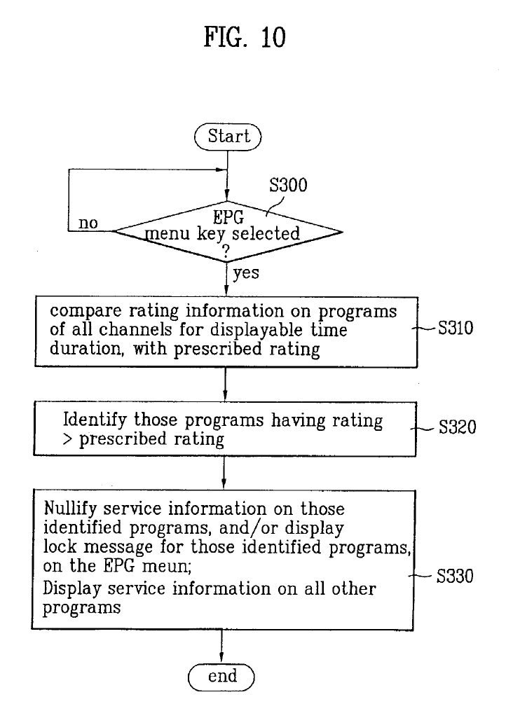

FIG. 10 is a flow chart illustrating the steps of a method of displaying EPG information on a display device according to a third embodiment of the present invention. This method is implementable by the display system shown in FIG. 5.

Referring to FIG. 10, it is determined whether or not a viewer has selected an ‘EPG display key’ or the like to display an EPG menu on a display device screen (S300). This step is the same as step S200 or S100. If so, the parental ratings of certain programs for all channels are compared with the user's set parental rating (S310). In this case, said certain programs are those programs of all channels that are scheduled to be displayed on the EPG menu. This time is also referred to as an “EPG displayable time duration.” For instance, if the EPG menu is configured to display program information from the current time up to three hours thereafter (i.e., in this example, the EPG displayable time duration is three hours), then step S310 compares, for all channels, the parental ratings of programs to be displayed on the EPG for the EPG displayable time duration, with the user's set parental rating for the viewer. Based on these comparison results, those programs having a parental rating higher than the user's set parental rating are identified (S320). Here, one or more programs/channels may be identified, or no program/channel may be identified.

Then, the service information of those identified programs is not displayed on the EPG menu screen and/or a display lock message for those identified programs is displayed on the EPG menu. The service information on all other programs/channels is displayed on the EPG menu screen (S330) according to the current EPG displayable time duration.

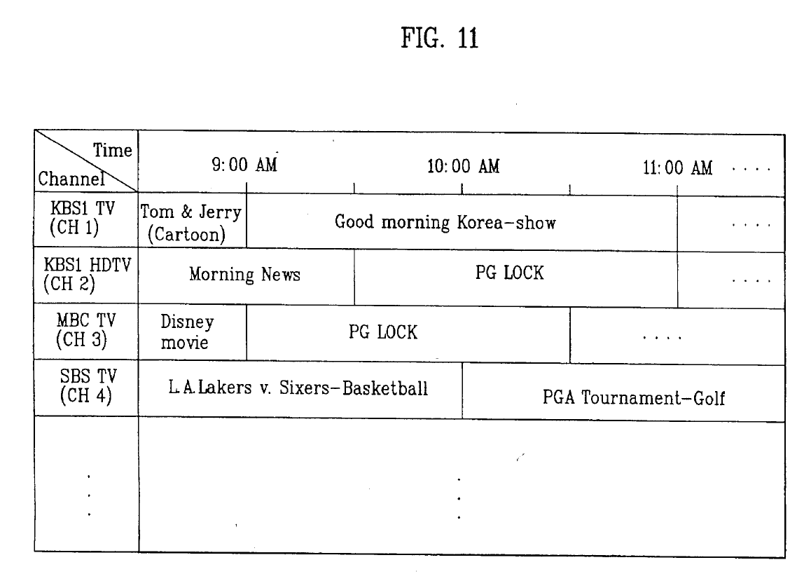

FIG. 11 shows an example of an EPG menu screen in which the method of FIG. 10 has been implemented. As shown in FIG. 11, in this example, based on the comparison and identification results in steps S310 and 320, program information on certain programs of different channels whose parental ratings are higher than the user's set parental rating for the viewer, are blocked out and/or are provided with a “PG lock” message. In this example, the program of Channel 2 to be broadcasted from 9:30 am to 11:00 am is shown with a “PG LOCK” message on the EPG menu, without any program information on this program. Similarly, the program of Channel 3 to be broadcasted from 9:00 am to 10:30 am is shown with a “PG LOCK” message on the EPG menu, without any program information on this program. This indicates that these two programs have parental ratings that are inappropriate for the current viewer. Here, the EPG displayable time duration is three hours since the EPG menu of FIG. 11 shows programs to be broadcasted between 8:30 am to 11:30 am. As the current time changes, then the EPG menu screen is updated as well.

As has been explained, the TV and method for displaying an EPG of the TV according to the present invention block, not only the audio and video of the programs themselves according to a set parental rating, but also block the channel listing and/or the channel service information of channels in an EPG, thereby providing a more complete parental control mechanism with improved product reliability.

It will be apparent to those skilled in the art that various modifications and variations can be made in the TV and method for displaying an EPG of a TV of the present invention without departing from the spirit or scope of the invention. Thus, it is intended that the present invention cover the modifications and variations of this invention provided they come within the scope of the appended claims and their equivalents.

What is claimed is:

1. A method for controlling an electronic program guide (EPG) for a display device, the method comprising:
displaying an EPG on the display device;
receiving a selection of a particular channel from the displayed EPG;
comparing parental rating information of the selected channel with prestored parental rating information; and
selectively displaying, in the EPG, program information of the selected channel based on the comparison results.

2. The method of claim 1, wherein the comparing step includes:
comparing a parental rating of a current program of the selected channel with a preset parental rating of the prestored parental rating information for a current viewer.

3. The method of claim 2, wherein the selectively displaying step includes:
blocking at least a portion of the program information of the selected channel, if the comparing step determines that the parental rating of the current program of the selected channel is higher than the preset parental rating for the current viewer; and
excluding a display of said portion of the program information in the EPG.

4. The method of claim 3, wherein the selectively displaying step further includes:
displaying, in the EPG, a message indicating a parental control lock of the selected channel.

5. The method of claim 1, further comprising:
monitoring a number of channel selections made using a program index.

6. A method for controlling an electronic program guide (EPG) for a display device, the method comprising:
receiving an EPG display command;
comparing parental rating information of a current program for each of channels with prestored parental rating information responsive to the EPG display command; and
displaying the EPG, which selectively excludes a display of channel information on certain channels in the EPG, based on the comparison results.

7. The method of claim 6, wherein the comparing step includes:
comparing a parental rating of the current program of each of the channels with a preset parental rating of the prestored parental rating information for a current viewer.

8. The method of claim 7, wherein the displaying step includes:
blocking program information and the channel information of said certain channels, if the comparing step determines that the parental rating of the current program of each of said certain channels is higher than the preset parental rating for the current viewer; and
excluding a display of said blocked program information and channel information in the EPG.

9. The method of claim 8, wherein the displaying step further includes: excluding from the EPG any entry or information associated with said certain channels.

10. A method for controlling -an electronic program guide (EPG) for a display device, the method comprising:
receiving an EPG display command;
comparing, for each of channels, parental rating information of at least one program corresponding to an EPG displayable time duration, with prestored parental rating information responsive to the EPG display command; and
displaying the EPG, which selectively excludes a display of at least a portion of program information of certain channels in the EPG, based on the comparison results.

11. The method of claim 10, wherein the comparing step includes:
comparing, for each of the channels, a parental rating of at least one program corresponding to the EPG displayable time duration, with a preset parental rating of the prestored parental rating information for a current viewer.

12. The method of claim 11, wherein the displaying step includes:
blocking said portion of program information of said certain channels in the EPG, if the comparing step determines that the parental rating of said at least one program corresponding to the EPG displayable time duration is higher than the preset parental rating for the current viewer; and
excluding a display of said portion of program information of said certain channels in the EPG.

13. The method of claim 12, wherein the displaying step further includes:
displaying, in the EPG, a message indicating a parental control lock of said certain channels.

14. An apparatus for controlling an electronic program guide (EPG), the apparatus comprising:
a display device to display thereon an EPG;
an input unit to receive a selection of a particular channel from the displayed EPG; and
a controller to compare parental rating information of the selected channel with prestored parental rating information, and to selectively display, in the EPG, program information of the selected channel based on the comparison results.

15. The apparatus of claim 14, wherein the controller compares a parental rating of a current program of the selected channel with a preset parental rating of the prestored parental rating information for a current viewer.

16. The apparatus of claim 15, wherein the controller controls to block at least a portion of the program information of the selected channel, if the parental rating of the current program of the selected channel is higher than the preset parental rating for the current viewer, and excludes a display of said portion of the program information in the EPG.

17. The apparatus of claim 16, wherein the display device displays, in the EPG, a message indicating a parental control lock of the selected channel.

18. The apparatus of claim 14, wherein the controller monitors a number of channel selections made using a program index.

19. The apparatus of claim 14, further comprising:
a demultiplexing part to receive a digital broadcasting signal composed of audio, video, and service information and to demultiplex the digital broadcast signal;
an audio/video (A/V) decoder to decoding the demultiplexed audio and video information;
a data parsing part to receive and parse the demultiplexed service information to separate various channel information; and
a storage unit to store therein the separated channel information in a predetermined format,
wherein the controller obtains the parental rating information of the selected channel from the channel information stored in the storage unit.

20. An apparatus for controlling an electronic program guide (EPG), the apparatus comprising:
an input unit to receive an EPG display command;
a controller to compare parental rating information of a current program for each of channels with prestored parental rating information responsive to the EPG display command; and
a display device to display the EPG, which selectively excludes a display of channel information of certain channels in the EPG, based on the comparison results.

21. The apparatus of claim 20, wherein the controller compares a parental rating of the current program of each of the channels with a preset program rating of the prestored parental rating information for a current viewer.

22. The apparatus of claim 21, wherein the controller controls to block program information and the channel information of said certain channels, if the parental rating of the current program of each of said certain channels is higher than the preset parental rating for the current viewer, and excludes a display of said blocked program information and channel information in the EPG.

23. The apparatus of claim 22, wherein the controller further excludes from the EPG any entry or information associated with said certain channels.

24. The apparatus of claim 20, further comprising:
a demultiplexing part to receive a digital broadcasting signal composed of audio, video, and service information and to demultiplex the digital broadcast signal;
an audio/video (A/V) decoder to decoding the demultiplexed audio and video information;
a data parsing part to receive and parse the demultiplexed service information to separate various channel information; and
a storage unit to store therein the separated channel information in a predetermined format,
wherein the controller obtains the parental rating information of the current program for each of channels from the channel information stored in the storage unit.

25. An apparatus for controlling an electronic program guide (EPG), the apparatus comprising:
an input unit to receive an EPG display command;
a controller to compare, for each of channels, parental rating information of at least one program corresponding to an EPG displayable time duration, with prestored parental rating information responsive to the EPG display command; and
a display device to display the EPG, which selectively excludes a display of at least a portion of program information of certain channels in the EPG, based on the comparison results.

26. The apparatus of claim 25, wherein the controller compares, for each of the channels, a parental rating of at least one program corresponding to the EPG displayable time duration, with a preset parental rating of the prestored parental rating information for a current viewer.

27. The apparatus of claim 26, wherein the controller controls to block said portion of program information of said certain channels in the EPG, if the parental rating of said at least one program corresponding to the EPG displayable time duration is higher than the preset parental rating for the current viewer, and excludes a display of said portion of the program information of said certain channels in the EPG.

28. The apparatus of claim 27, wherein the display device displays, in the EPG, a message indicating a parental control lock of said certain channels.

29. The apparatus of claim 25, further comprising:
a demultiplexing part to receive a digital broadcasting signal composed of audio, video, and service information and to demultiplex the digital broadcast signal;
an audio/video (A/V) decoder to decoding the demultiplexed audio and video information;
a data parsing part to receive and parse the demultiplexed service information to separate various channel information; and
a storage unit to store therein the separated channel information in a predetermined format,
wherein the controller obtains the parental rating information of at least one program corresponding to the EPG displayable time duration for each of channels from the channel information stored in the storage unit.
